(19) United States
(12) Patent Application Publication
(10) Pub. No.: US 2014/0201586 A1
(43) Pub. Date: Jul. 17, 2014

(54) Latency

(71) Applicant: NOKIA SOLUTIONS AND NETWORKS OY, Espoo (FI)

(72) Inventors: Kari Pekka Pajukoski, Oulu (FI); Bernhard Raaf, Neuried (DE); Esa Tapani Tiirola, Kempele (FI)

(73) Assignee: NOKIA SOLUTIONS AND NETWORKS OY, Espoo (FI)

(21) Appl. No.: 14/126,166

(22) PCT Filed: Jun. 15, 2011
(86) PCT No.: PCT/EP2011/059891

§ 371 Date: Jan. 22, 2014

(51) Int. Cl. H04L 1/18

(52) U.S. Cl. CPC H04L 1/1816
USPC 714/748

(57) ABSTRACT

The invention relates to an apparatus including at least one processor and at least one memory including a computer program code, the at least one memory and the computer program code configured to, with the at least one processor, cause the apparatus at least to: prepare a transmission of a no-acknowledgement message to be conveyed to a node, when a part of a transport block has been received erroneously or an indication of inadequate quality of at least part of the transport block has been obtained.

### FIELD

The invention relates to apparatuses, methods, a system, computer programs, computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Automatic repeat request (ARQ) or hybrid automatic repeat request (HARQ) performs an error-control system wherein a receiver generates a request for retransmission, if an error in transmission is detected.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: prepare a transmission of a no-acknowledgement message to be conveyed to a node, when a part of a transport block has been received erroneously or an indication of inadequate quality of at least part of the transport block has been obtained.

According to another aspect of the present invention, there is provided an apparatus comprising: at least one processor and at least one memory including a computer program code, the at least one memory and the computer program code configured to, with the at least one processor, cause the apparatus at least to: prepare a transport block for data conveyance, the transport block comprising an indication of a quality of at least part of a transport block.

According to yet another aspect of the present invention, there is provided a method comprising: preparing a transmission of a no-acknowledgement message to be conveyed to a node, when a part of a transport block has been received erroneously or an indication of inadequate quality of at least part of the transport block has been obtained.

According to yet another aspect of the present invention, there is provided a method comprising: preparing a transport block for data conveyance, the transport block comprising an indication of a quality of at least part of a transport block.

According to yet another aspect of the present invention, there is provided an apparatus comprising: means for preparing a transmission of a no-acknowledgement message to be conveyed to a node, when a part of a transport block has been received erroneously or an indication of inadequate quality of at least part of the transport block has been obtained.

According to yet another aspect of the present invention, there is provided an apparatus comprising: means for preparing a transport block for data conveyance, the transport block comprising an indication of a quality of at least part of a transport block.

According to yet another aspect of the present invention, there is provided a computer program embodied on a computer-readable storage medium, the computer program comprising program code for controlling a process to execute a process, the process comprising: preparing a transmission of a no-acknowledgement message to be conveyed to a node, when a part of a transport block has been received erroneously or an indication of inadequate quality of at least part of the transport block has been obtained.

According to yet another aspect of the present invention, there is provided a computer program embodied on a computer-readable storage medium, the computer program comprising program code for controlling a process to execute a process, the process comprising: preparing a transport block for data conveyance, the transport block comprising an indication of a quality of at least part of a transport block.

### LIST OF DRAWINGS

Some embodiments of the present invention are described below, by way of example only, with reference to the accompanying drawings, in which

FIG. 1 illustrates an example of a system;

FIG. 2 is a flow chart;

FIG. 3 is another flow chart;

FIG. 4 illustrates examples of apparatuses, and

FIG. 5 illustrates other examples of apparatuses.

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

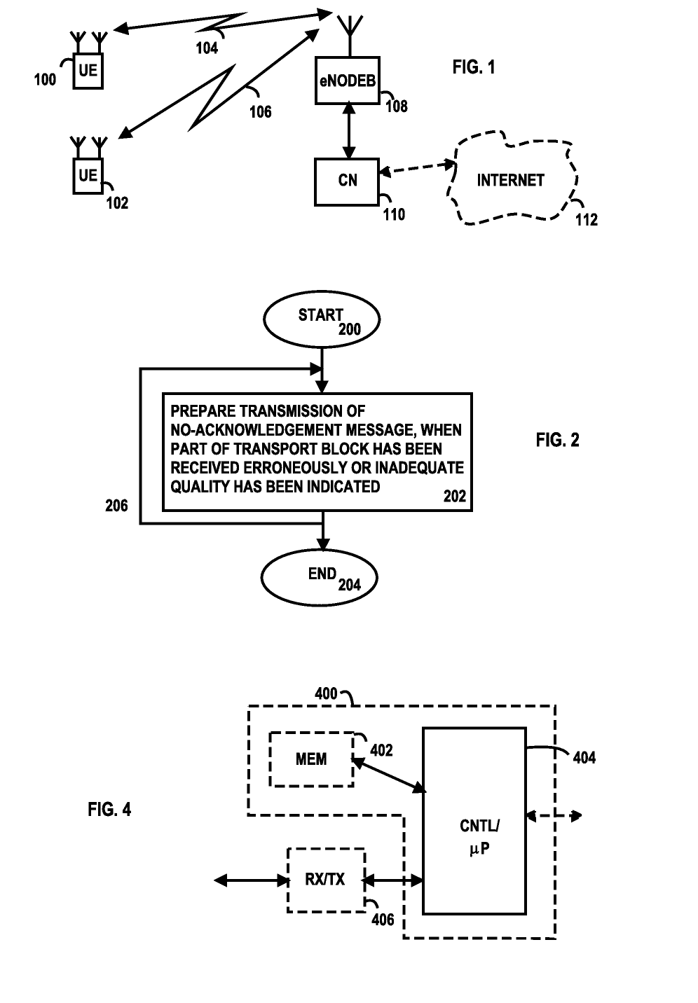

Embodiments are mainly targeted to so-called “Beyond 4G” systems which are now only in the developing phase. Systems beyond 4G are designed to fulfill international mobile telecommunications advanced+ (IMT-Advanced+) requirements, at least as to data rates. Common assumption in the field is that rata rates will be 10 Gbit/s for a low mobility case and 1 Gbit/s for a high mobility case. The structure and elements of the systems are not yet decided. However, it is presumed that one option of such a system when specified will resemble that of the Long Term Evolution (LTE) Advanced or it will be a development of it. Thus, in the following, an example of the system is described as if it were according to an LTE Advanced system. It is however emphasized that FIG. 1 only shows an assumption of a not yet specified system. It should be understood that typically the names of network elements are somewhat different than the ones used in an earlier system generation to make it easier to tell the difference. However, due to the nature of communication systems, basic tasks the network has to carry out usually remain quite the same but implementations vary due to different, typically more demanding or progressive, requirements.

In the following, different exemplifying embodiments will be described using, as an example of an access architecture to which the embodiments may be applied, a radio access architecture based on LTE Advanced, LTE-A, that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. For example, the embodiments are applicable to both frequency division duplex (FDD) and time division duplex (TDD).

In an orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB (“e” stands for evolved) needs to know channel quality of each user device and/or the preferred precoding matrices (and/or other multiple input-multiple output (MIMO) specific feedback information, such as channel quantization) over the allocated sub-bands to schedule transmissions to user devices. Required information is usually signalled to the (e)NodeB.

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

FIG. 1 shows a part of a radio access network based on E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1 shows user devices 100 and 102 configured to be in a wireless connection on one or more communication channels 104, 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to a base station, an access point or any other type of interfacing device including a relay station capable of operating in a wireless environment.

The (e)NodeB includes transceivers, for example. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeB 108 of FIG. 1 may provide any kind of these cells. A cellular radio system may be implemented as a multilayer network including several kinds of cells. Typically, in multilayer networks, one node B provides one kind of a cell or cells, and thus a plurality of node Bs are required to provide such a network structure.

Studies and extrapolations from recent developments predict a total mobile broadband traffic increase by a factor of 100 or even up to 1000 until 2020. These figures assume 10 times increase in broadband mobile subscribers and up to 100 times higher traffic per user. The relative fastest growth is expected in smartphones. Besides the overall traffic, the achievable throughput per user has to be increased significantly. A rough estimation predicts an at least 10 times increase in average as well as in peak data rate. Moreover, some essential design criteria have to be paid higher attention to than it used to be today's systems. One important target is latency minimisation or optimisation.

Nowadays, LTE/LTE-Advanced with data rates 0.1-1 Gbps provides 10 ms latency (round trip time). Generally speaking, latency must decrease at the same pace as the data rate increases.

It is generally understood that a very small latency (such as 0.1 ms) is beneficial, if the content is located at proximity, such as in the same office network or the same campus. Otherwise there would be too much delay on the link between the server and the access point.

Physical layer latency is hard-coded in existing radio systems. For instance the LTE-Advanced specification defines processing requirements (i.e., computational complexity) for the node and/or user device receiver. These requirements may be presented in the form of a node and/or user device processing time after receiving a physical downlink control channel (PDSCH) and/or physical uplink shared channel (PUSCH) message and before sending a hybrid automatic repeat request (HARQ) acknowledgment/no-acknowlegdement (ACK/NACK) message. A physical layer latency, which defines node and/or user device processing time requirements, depends mainly on computational complexity and processing parallelization possibilities.

A hybrid-automatic repeat request (HARQ) is an important feature to enhance the performance of packet data transmission. Usually, the HARQ controls and initiates packet retransmission on layer 1 (physical layer), to reduce retransmission delay caused by higher layer transmission. In the case of a link error, caused for instance by interference, a receiving entity may request retransmission of corrupted data packets. HARQ is a “stop and wait” protocol of a nature: a subsequent transmission may take place only after receiving an ACK/NACK from a receiving entity.

HARQ is currently typically implemented by using two rate-matching stages and a virtual memory buffer. In principle, the first rate matching stage matches a selected number of input bits to the virtual buffer. The second rate matching stage matches the number of bits after the first rate matching stage to physical channel bits for one transmission time interval (TTI).

A fixed HARQ subsystem does not take into account variable data rates, variable latency requirements, variable signal processing capability or a variable HARQ operation point, for example .

The latency performance of LTE Rel-8/9/10 does not meet Beyond 4G targets. One aspect needing reconsidering is HARQ-retransmissions.

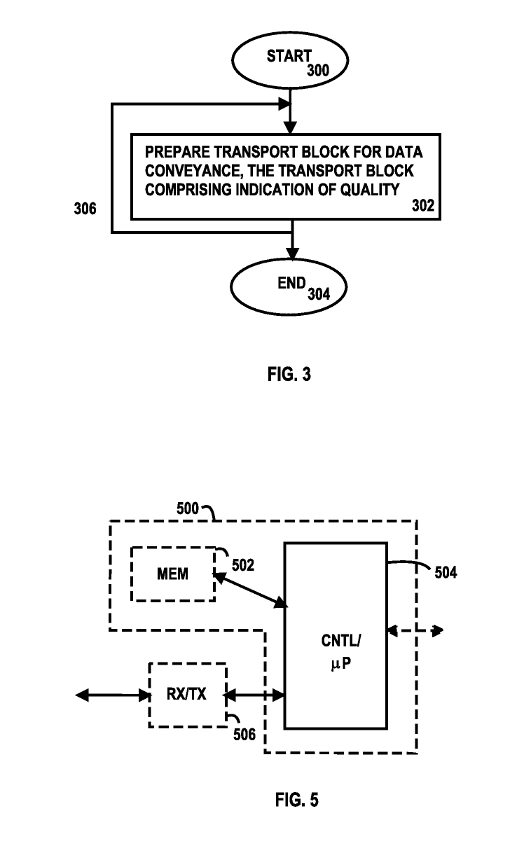

Some embodiments are disclosed in further details in relation to FIGS. 2 and 3. One target of some embodiments is to speed up HARQ retransmissions by allowing signalling of a NACK-message even before the corresponding packet has been received completely (or even before it has been sent or transmitted completely).

Some embodiments enable minimising HARQ re-transmission delay and relaxing processing requirements while achieving improved latency performance. Latency performance may be improved in particular for retransmitted data packets. It should be emphasized that usually these are the packets that determine general delay for higher layers or applications, because packets are typically segmented into a plurality of radio packets and a receiver has to wait until all physical layer packets have arrived.

The embodiment of FIG. 2 is usually related to a user device, home node or a web stick. The embodiment begins in block 200.

In block 202, a transmission of a no-acknowledgement message to be conveyed to a node, when a part of a transport block has been received erroneously or an indication of inadequate quality of at least part of the transport block has been obtained, is prepared. The retransmission procedure of the LTE-Advanced comprises a HARQ functionality which is described above.

Potential reasons for “early NACK” (that is to say a no-acknowledgement message conveyed earlier than in a conventional HARQ-procedure) may be that at least one coding block of a transport block has already been received erroneously or a receiver identifies that a channel or its interference conditions have deteriorated after a scheduling decision (or after a previous channel state information report), or that they are insufficient for the modulation coding scheme (MCS) selected by a transmitter (e.g. because reports have been lost or corrupted, and therefore the transmitter assumed incorrectly too good a signal-to-interference and noise-ratio (SINR) or used beamforming or precoding in a non-optimum manner).

Term “early NACK” denotes that a NACK-message is conveyed in an earlier phase than conventionally in current systems supporting Hybrid ARQ (hybrid automatic repeat request). The early NACK may be based on anticipated transmission time interval (TTI) quality according to predefined rules or policies.

In an embodiment, “early NACK” is signaled using an “on-off keying” principle in which a related acknowledgement state corresponds to “no transmission” in order to save power and reduce interference caused by an ACK/NACK signal. In other words, only NACK is signaled, whereas “no transmission” corresponds to the situation where the receiving node has not identified any reason to transmit “early NACK”. Early NACK may have a fixed or flexible timing relationship with relation to data reception. In the case of the flexible timing, a receiver node, such as a user device, is allowed to transmit “early NACK” using ACK/NACK resources corresponding to a first available ACK/NACK resource prior to a regular or conventional ACK/NACK. Hence, the “early NACK” may be transmitted using a first temporal resource that is available for (HARQ) feedback signaling. It should be appreciated that an early NACK may cancel or substitute a regular or conventional (ACK/)NACK, since it would be unnecessary redundancy and thus waste of resources. This embodiment may be based on an observation that a part of a transport block has been received erroneously.

In another embodiment, signaling both “early NACK” and “early ACK” is an option. This option may make timing flexible. The early ACK/NACK may be transmitted right after the entire packet is received and decoded correctly without the need to wait for the “regular ACK/NACK” procedure. In cases wherein the quality of a received signal is inadequate, even after a few Turbo decoding iterations, it may become obvious that the decoding metric does not improve and the turbo decoder does not start to converge. Thus an early NACK-message may be sent. This embodiment may be based on an indication of inadequate quality of at least part of a transport block.

Another embodiment may utilize not only “early NACK” but also some other signaling, such as a channel quality information (CQI) report, as a trigger for “early retransmission”. For this option a transmitting node (for example a (e)nodeB) and a receiving node (for example a user device) have sufficient flexibility to assign HARQ processes in a dynamic manner. If a user device reports channel quality regularly, a node may come to a conclusion based on these reports that a channel quality has decreased and send a retransmission.

An exemplary transport block (TB) with the duration of one TTI consists of multiple Turbo-coded coding blocks each having a separate cyclic redundancy check (CRC). “Early NACK” may be triggered immediately after a receiver identifies that a certain part of a transport block, such as one coding block, is erroneous or corrupted. It should be understood that due to interleaving, quality among different blocks is typically well aligned. Hence, already a first coding block may reflect the quality of the entire transport block quite accurately. It should also be appreciated that in order to enhance pipeline processing, interleaving should take place only in a frequency domain.

In the case the number of coding blocks is small (as may be when a data rate is low and/or TTI length is long), it is possible to arrange the coding blocks in such a manner that at least one (usually a small) coding block (a test coding block) or some other means indicating the quality of the coding block(s) accurately enough is provided. The test coding block may be arranged to be the first one in a transport block. It may also be located in another position in the transport block. The test coding block may have a low coding gain and therefore it may be transmitted with a lower code rate. This may not be efficient, but it relates only to a small part of data. Alternatively, it may be possible to increase the number of coding blocks by splitting a transmission time interval into multiple smaller coding blocks, again at the expense of a coding gain. One or more of these split coding blocks comprise an indication of inadequate quality of at least part of the transport block.

Usually, the concept of “early NACK” needs to be combined with other HARQ signaling. Systems supporting “early NACK” typically provide means to adjust HARQ processes in a flexible manner that is to say the usage of certain HARQ processes in certain uplink TTIs is not required. Thus asynchronous HARQ may be used whenever available in order to materialize enhanced HARQ feedback signaling in shortened retransmission latency.

In order NACK-messages may be sent flexibly in time, an indication to which TTI a message relates to is added to the NACK-messages. This may be a single bit indicating whether it is an early ACK/NACK or a conventional one. Another option is that multiple bits (e.g., two bits) may be used for indicating also a HARQ process number.

One example of ACK/NACK signaling is that “early NACK” is transmitted at the same time and using the same resources as a conventional ACK/NACK for a block. In this manner, “early NACK” for a following block may implicitly also indicate an ACK for the block. This may be implemented by using the “on-off keying” approach, by choosing the polarity of a transmitted early NACK to be different from the one of an ordinary ACK. In complex coordinates, the ACK may be +1 and the “early” NACK may be −1, while an ordinary ACK may be coded as 0. This embodiment provides an option to save resources. Another option is to apply quadrature phase shift keying (QPSK) constellation in a such a manner that “early (ACK/)NACK” and ordinary ACK/NACK are transmitted using a same modulation symbol.

The embodiment ends in block 204. The embodiment is repeatable in many ways. One example is shown by arrow 206 in FIG. 2.

Another embodiment is usually related to a node, host or server. The embodiment will be described by means of FIG. 3. The embodiment begins in block 300.

In block 302, a transport block for data conveyance is prepared. The transport block comprises an indication of quality.

The quality indication may be implemented by means of a transport block specific cyclic redundancy check (CRC).

In the case the number of coding blocks is small (as may be when a data rate is low and/or TTI length is long), it is possible to arrange the coding blocks in such a manner that at least one certain (usually a small) coding block (a test coding block) or some other means indicating the quality of the coding block(s) accurately enough is provided. The test coding block is usually arranged to be the first one in a transport block. It may also be located in another position in the transport block. The test coding block may have a low coding gain and therefore it may be transmitted with a lower code rate. This may not be efficient, but it relates only to a small part of data. Alternatively, it may be possible to increase the number of coding blocks by splitting a transmission time interval into multiple smaller coding blocks, again at the expense of a coding gain. A test coding block may be used as an indication of quality.

The embodiment ends in block 304. The embodiment is repeatable in many ways. One example is shown by arrow 306 in FIG. 3.

The steps/points, signaling messages and related functions described above in FIGS. 2 and 3 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, transmitting and/or receiving may herein mean preparing a data conveyance, transmission and/or reception, preparing a message to be conveyed, transmitted and/or received, or physical transmission and/or reception itself, etc. on a case by case basis.

An embodiment provides an apparatus which may be any user device, home node, web stick or any other suitable apparatus capable to carry out processes described above in relation to FIG. 2.

Another embodiment provides an apparatus which may be any server, node, host or any other suitable apparatus capable to carry out processes described above in relation to FIG. 3.

FIG. 4 illustrates a simplified block diagram of an apparatus according to an embodiment especially suitable for communicating a no-acknowledgement information.

As an example of an apparatus according to an embodiment, it is shown an apparatus 400, such as a user device, relay node or web stick, including facilities in a control unit 404 (including one or more processors, for example) to carry out functions of embodiments according to FIG. 2.

In FIG. 4, block 406 includes parts/units/modules need for reception and transmission, usually called a radio front end, RF-parts, radio parts, etc. This block is optional.

Another example of an apparatus 400 may include at least one processor 304 and at least one memory 402 including a computer program code, the at least one memory and the computer program code configured to, with the at least one processor, cause the apparatus at least to: prepare a transmission of a no-acknowledgement message to be conveyed to a node, when a part of a transport block has been received erroneously or an indication of inadequate quality of at least part of the transport block has been obtained.

Yet another example of an apparatus comprises means 404 for preparing a transmission of a no-acknowledgement message to be conveyed to a node, when a part of a transport block has been received erroneously or an indication of inadequate quality of at least part of the transport block has been obtained.

Yet another example of an apparatus comprises a preparing unit configured to prepare a transmission of a no-acknowledgement message to be conveyed to a node, when a part of a transport block has been received erroneously or an indication of inadequate quality of at least part of the transport block has been obtained.

FIG. 5 illustrates a simplified block diagram of an apparatus according to an embodiment especially suitable for communicating a no-acknowledgement information.

As an example of an apparatus according to an embodiment, it is shown an apparatus 500, such as a server, host or node, including facilities in a control unit 504 (including one or more processors, for example) to carry out functions of embodiments according to FIG. 3.

In FIG. 5, block 506 includes parts/units/modules need for reception and transmission, usually called a radio front end, RF-parts, radio parts, etc. This block is optional.

Another example of an apparatus 500 may include at least one processor 504 and at least one memory 502 including a computer program code, the at least one memory and the computer program code configured to, with the at least one processor, cause the apparatus at least to: prepare a transport block for data conveyance, the transport block comprising an indication of a quality of at least part of a transport block.

Yet another example of an apparatus comprises means 504 for preparing a transport block for data conveyance, the transport block comprising an indication of a quality of at least part of a transport block.

Yet another example of an apparatus comprises a preparing unit configured to prepare a transport block for data conveyance, the transport block comprising an indication of a quality of at least part of a transport block.

It should be understood that the apparatuses may include or be coupled to other units or modules etc, such as radio parts or radio heads, used in or for transmission and/or reception. This is depicted in FIGS. 4 and 5 as optional blocks 406 and 506.

Although the apparatuses have been depicted as one entity in FIGS. 4 and 5, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be a software application, or a module, or a unit configured as arithmetic operation, or as a program (including an added or updated software routine), executed by an operation processor. Programs, also called program products or computer programs, including software routines, applets and macros, may be stored in any apparatus-readable data storage medium and they include program instructions to perform particular tasks. Computer programs may be coded by a programming language, which may be a high-level programming language, such as objective-C, C, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable medium, configured to control a processor to perform embodiments of the methods described above. The computer readable medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers. The computer readable medium may be a non-transitory medium.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
prepare a transmission of a no-acknowledgement message to be conveyed to a node, when a part of a transport block has been received erroneously or an indication of inadequate quality of at least part of the transport block has been obtained.

2. The apparatus of claim 1, wherein the no-acknowledgement message is in relation to a hybrid automatic repeat request (HARQ) procedure.

3. The apparatus of claim 1, wherein the no-acknowledgement message is transmitted using a first temporal resource available for Hybrid automatic repeat request (HARQ) feedback signaling.

4. The apparatus of claim 1, wherein the no-acknowledgement message is signaled using an “on-off keying” principle.

5. The apparatus of claim 1, the apparatus further being caused to:
utilize a channel quality information (CQI) report as means for evaluating the need for the no-acknowledgement message.

6. The apparatus of claim 1, wherein the part of the transport block is a coding block.

7. The apparatus of claim 1, wherein the indication of inadequate quality of at least part of the transport block is at least one specified test block located in the transport block.

8. The apparatus of claim 1, wherein a transmission time interval is split into multiple smaller coding blocks of which split coding blocks at least one comprises the indication of inadequate quality of at least part of the transport block.

9. The apparatus of claim 1, the apparatus comprising a user device, relay node or web stick.

10. (canceled)

11. An apparatus comprising:
at least one processor and at least one memory including a computer program code, the at least one memory and the computer program code configured to, with the at least one processor, cause the apparatus at least to:
prepare a transport block for data conveyance, the transport block comprising an indication of a quality of at least part of a transport block.

12. The apparatus of claim 11, wherein the indication of inadequate quality of at least part of the transport block is at least one specified test block located in the transport block.

13. The apparatus of claim 11, wherein a transmission time interval is split into multiple smaller coding blocks of which split coding blocks at least one comprises the indication of inadequate quality of at least part of the transport block.

14. The apparatus of claim 11, the apparatus comprising a server, node or host.

15. (canceled)

16. A method comprising:
preparing a transmission of a no-acknowledgement message to be conveyed to a node, when a part of a transport block has been received erroneously or an indication of inadequate quality of at least part of the transport block has been obtained.

17. The method of claim 16, wherein the no-acknowledgement message is in relation to a hybrid automatic repeat request (HARQ) procedure.

18. The method of claim 16, wherein the no-acknowledgement message is transmitted using a first temporal resource available for Hybrid automatic repeat request (HARQ) feedback signaling.

19. The method of claim 16, wherein the no-acknowledgement message is signaled using an “on-off keying” principle.

20. The method of claim 16, further comprising: utilize a channel quality information (CQI) report as means for evaluating the need for the no-acknowledgement message.

21. The method of claim 16, wherein the part of the transport block is a coding block.

22. The method of claim 16, wherein the indication of inadequate quality of at least part of the transport block is at least one specified test block located in the transport block.

23. The apparatus of claim 16, wherein a transmission time interval is split into multiple smaller coding blocks of which split coding blocks at least one comprises the indication of inadequate quality of at least part of the transport block

24. (canceled)

25. A method comprising:
preparing a transport block for data conveyance, the transport block comprising an indication of a quality of at least part of a transport block.

26. The method of claim 25, wherein the indication of inadequate quality of at least part of the transport block is at least one specified test block located in the transport block.

27. The method of claim 25, wherein a transmission time interval is split into multiple smaller coding blocks of which split coding blocks at least one comprises the indication of inadequate quality of at least part of the transport block

28.-39. (canceled)
